(19) United States
(12) Patent Application Publication
(10) Pub. No.: US 2006/0060230 A1
(43) Pub. Date: Mar. 23, 2006

(54) Ware washing installation

(76) Inventors: Juergen Litterst, Appenweier (DE); Dieter Kaiser, Friesenheim (DE); Udo Erb, Lahr (DE); Dietrich Berner, Waldstetten (DE)

Correspondence Address: THOMPSON HINE LLP, 2000 COURTHOUSE PLAZA N.E., 10 WEST SECOND STREET, DAYTON, OH, 45402-1758, US

(21) Appl. No.: 11/225,911

(22) Filed: Sep. 14, 2005

(30) Foreign Application Priority Data
Sep. 18, 2004 (DE) 10 2004 045 445.0

(51) Int. Cl. B08B 3/00; B08B 3/12

(52) U.S. Cl. 134/56 D; 134/172; 134/198

(57) ABSTRACT

Ware washing installation, containing at least one conveyor-type ware washer which is divided into a ware cleaning appliance (2) and a water treatment station (4) separated spatially from each other.

The invention relates to a ware washing installation, containing at least one conveyor-type ware washer, preferably a flight-type ware washer or a rack-conveyor ware washer, according to the preamble of Claim 1.

Conveyor-type ware washers according to the prior art contain a ware cleaning device and recirculation circuits with elements for water heating and/or for water purification and/or for the intermixing of various water streams, in order thereby to refresh more heavily contaminated water with less heavily contaminated water.

A ware washer is shown, for example, in the publication of an Abstract of Invention of Russian Patent RU 2 150 228 C1.

There are two types of conveyor-type ware washers. One type is flight-type ware washers, in which the conveyor belt has holding elements for holding the ware to be cleaned. The other type is rack-conveyor ware washers, in which a conveyor mechanism transports racks which contain the ware. In all types of machine, the conveyor belt or the conveyor mechanism is provided with a multiplicity of interspaces or passage orifices, through which water sprayed onto the ware can run off downwards.

Ware washers are suitable not only for the cleaning of ware in the form of plates, cups and bowls, but also for the cleaning of ware in the form of spoons, knives and forks and for the cleaning of trays and also for the cleaning of other articles used in catering establishments, in particular in hotels, restaurants and canteens. Within the scope of the present description, therefore, the expression “ware” is used to represent all articles which can normally be cleaned by means of a ware washer, in order to simplify the description of the invention.

The invention is to achieve the object of designing a ware washing installation which contains at least one conveyor-type ware washer, in such a way that the process of cleaning the ware becomes more independent of the provision of water for the cleaning operation.

This object is achieved, according to the invention, by means of the features of Claim 1.

Accordingly, the invention relates to a ware washing installation, containing at least one conveyor-type ware washer, preferably a flight-type ware washer or a rack-conveyor ware washer, characterized in that the at least one conveyor-type ware washer is divided into a ware cleaning appliance and a water treatment station arranged spatially separately from the latter, and in that at least one recirculation circuit is formed, in which water is recirculated from the water treatment station to the ware cleaning appliance and back again, the recirculation circuit having, in the ware cleaning appliance, spray nozzles for the spraying of water onto the ware and at least one water discharge orifice for the recirculation of sprayed water back to the water treatment station.

Advantages of the invention: the water can be treated separately from the ware cleaning appliance, for example purified, heated, conveyed by pumps and/or varied by the intermixing of water of different quality and/or by the intermixing of water with other liquids or with additives.

Another advantage is that the components for the provision of water, in particular purification appliances and tanks, can be designed to be larger and to have a more effective action than in the prior art where they are integrated into the conveyor-type ware washer. This results in a better purification of the water, which, in turn, leads to the fact that the same water can be reused more frequently before it has to be replaced by fresh water. The water consumption can thereby be reduced substantially.

A further advantage of the invention is that all the maintenance-intensive parts are no longer arranged at the ware cleaning appliance, but separately from the latter in the water treatment station which provides the water for cleaning the ware. As a result, cleaning work, maintenance work, testing activities and repair work at the water treatment station can be carried out, without disrupting the cleaning operation in the ware cleaning appliance and without disturbing persons who are using the ware cleaning appliance.

Further features and advantages may be gathered from the following description of the invention and from the patent claims. All the features of the invention which are described above and below can be utilized individually and in part combination in order to form further machine variants.

According to a preferred embodiment of the invention, the water treatment station is arranged at least one storey lower than the at least one ware cleaning appliance. The advantage of this is that water sprayed in the ware cleaning appliance can flow back into the water treatment station due to gravity, without pumps being required.

According to another embodiment of the invention, the water treatment station is arranged on the same storey as the at least one ware cleaning appliance. The advantage of this is that the invention can also be employed when there is only one storey available. The water treatment station is preferably arranged in a different room from the at least one ware cleaning appliance.

If the water treatment station is arranged in a different room from the at least one ware cleaning appliance in another storey or on the same storey, this affords the advantage that only the ware cleaning appliance, for use by a large number of people, has to be designed with a high-quality visual appearance, whereas the water treatment station, which constitutes a maintenance-intensive machine part, is not visible to the public and can expediently be designed as a machine room.

According to a preferred embodiment of the invention, the water treatment station has at least one water purification device which is integrated in each case into one of the recirculation circuits. As a result, the soil occurring in the purification device can be disposed of in the water treatment station, without disturbing the operating personnel using the ware cleaning appliance. Furthermore, dirty water or soil removed from the water can be disposed of in a more effective way than would be possible in the region of the ware cleaning appliance.

According to a preferred embodiment, it is also possible to remove the soil occurring during the cleaning of ware continuously from the water in the water treatment station, instead of collecting such soil in soil containers and removing it discontinuously. For this purpose, a preferred embodiment of the invention has a soil discharge device for the continuous discharge of soil from the water.

The water treatment station preferably contains a screening device and/or a diaphragm-filter device. According to a particular embodiment of the invention, the ware cleaning appliance contains a plurality of, for example two cleaning zones, the water treatment station having a screening device for the first cleaning (washing) zone and a diaphragm-filter device for the second cleaning (rinse) zone.

According to a likewise preferred embodiment of the invention, the screening device has a rotating screening cylinder, through which the water is conducted, and a solids discharge device is arranged inside the screening cylinder for the discharge of solids (soil) from the water.

The water treatment station preferably contains at least one water storage tank which is integrated in each case into one of the recirculation circuits and which has a recirculation-water inlet and a recirculation-water outlet. Such water storage tanks may advantageously be used for various purposes. The water storage tank may contain a heating device, preferably electrical heating or a heat exchanger for heating the water. Furthermore, a screening device of the water treatment station may be arranged above such a water storage tank, so that the water screened by it flows into the water storage tank due to gravity. Furthermore, there is the advantageous possibility of providing a plurality of water storage tanks which are integrated into recirculation circuits of various wash zones and/or into one or more rinse zones and which are flow-connected to one another by means of water overflow devices, so that water can flow in a cascade-like manner in each case from a water storage tank which contains cleaner water into a water storage tank which contains dirtier water and is refreshed by the cleaner water. Advantageously, only the water storage tank which contains the dirtiest water contains an overflow for the removal of contaminated water from the water treatment station.

According to a further particular embodiment of the invention, the water treatment station contains a number, corresponding to the number of recirculation circuits, of operating pumps or operating-pump groups, the suction side of which is flow-connected in each case to the water outlet side of the water treatment station, for the conveyance of water from the water treatment station to the ware cleaning appliance. Consequently, these pumps, too, are arranged spatially separately from the at least one ware cleaning appliances on the same storey as the water treatment station. Pumps are maintenance-intensive components. Their maintenance and exchange can therefore be carried out without disturbances in the region of the ware cleaning appliance.

At least one of the recirculation circuits includes a reserve pump which is connected in parallel to the operating pump or the operating-pump group and which can be selectively switched on. As a result, even in the event of an operational failure of an operating pump, the cleaning process in the ware cleaning appliance can continue uninterruptedly by means of the reserve pump.

According to a particular embodiment of the invention, the water treatment station has connected to it a plurality of ware cleaning appliances which are in each case spatially separated from it and which, together with this single water treatment station, form a number of conveyor-type ware washers which is equal to the number of ware cleaning appliances. In this case, between each ware cleaning appliance and the water treatment station, at least one of the recirculation circuits is formed, in which water is recirculated from the water treatment station to the respective ware cleaning appliance and then back again, and each recirculation circuit has, in the respective ware cleaning appliance, spray nozzles for the spraying of water onto the ware and at least one water discharge orifice for the recirculation of sprayed water back to the water station. This embodiment of the invention has several additional advantages. Only one service room is required for the cleaning-intensive and maintenance-intensive components, such as, for example, pumps, water tanks, screens, filters, etc. The soil, in particular solids, from all the ware cleaning appliances and consequently from all the conveyor-type ware washers occurs at only a single place where the water treatment station is located. Consequently, a more efficient and a more cost-effective removal of soil from the water with which the ware is cleaned is also possible.

According to a particular embodiment of the invention, at least one recirculation circuit of one ware cleaning appliance and at least one recirculation circuit of another ware cleaning appliance are connected in parallel to one another and are connected to a common operating-pump group of the water treatment station, the operating-pump group having at least a number of parallel-connected operating pumps which corresponds to the number of ware cleaning appliances. As a result, in the event of a failure (maintenance work; defect) of a pump, any one of the ware cleaning appliances which is currently required the least can be switched off, whilst all the other ware cleaning appliances are ready for operation.

According to a particular embodiment of the invention, a reserve pump which can be selectively switched on is connected in parallel to such an operating-pump group. The advantage of this is that only a single reserve pump is required for any multiplicity of conveyor-type ware washers, and, in the event of a failure of an operating pump of the operating-pump group, all the conveyor-type ware washers remain fully functionable.

The invention is described below by means of a preferred exemplary embodiment, with reference to the accompanying drawing in which:

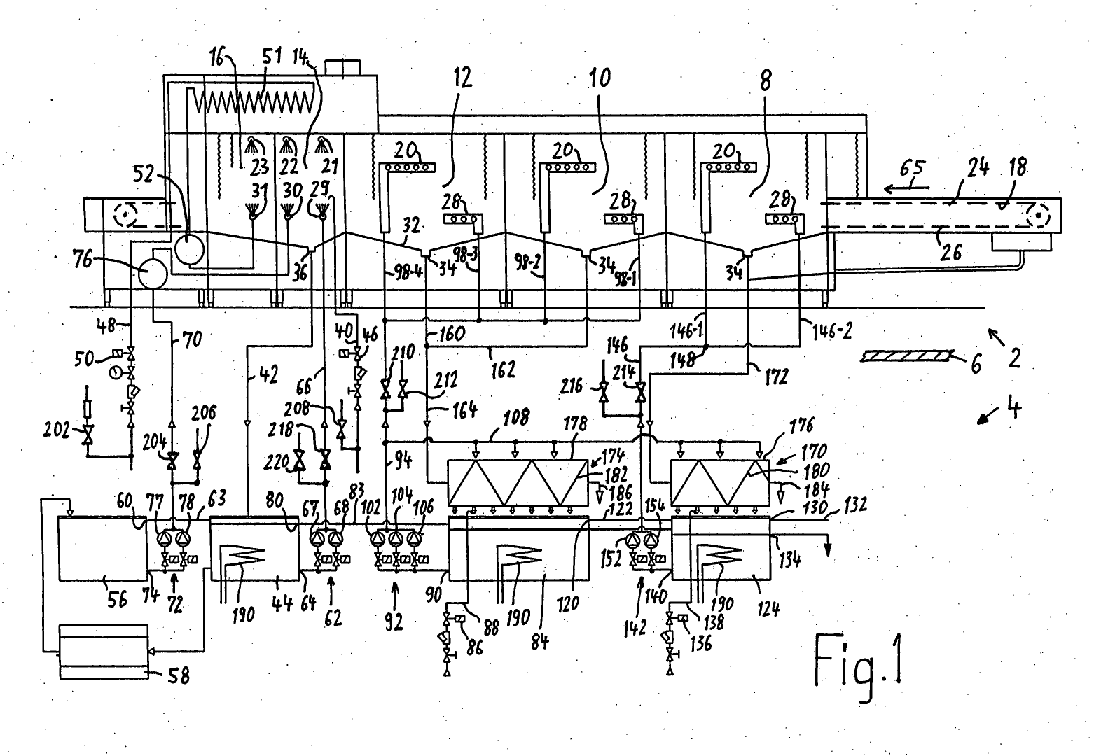

FIG. 1 shows diagrammatically a ware washing installation according to the invention, without the invention being restricted to the illustrated number of individual elements, regions or zones.

The water treatment station described below may be designed in various ways for one or more or all of the functions described below, such as, in particular, the purification of the water flowing out of the at least one ware cleaning appliance by filtering, screening, flushing-out and/or mechanical discharge of solids and other impurities from the water and/or the partial removal of dirty water and/or the dilution of dirty water with fresh water or with less heavily contaminated water already used, and/or the heating of the water before it is recirculated from the water treatment station back to the ware cleaning appliance. Instead or at the same time, the treatment of the water may also involve a pump arrangement with a plurality of pumps distributing the water to a plurality of ware cleaning appliances and/or to various wash zones and/or various rinse zones of one or more ware cleaning appliances.

The ware washing installation according to the invention, described below with reference to FIG. 1, is optimized by means of a multiplicity of the features mentioned above.

FIG. 1 shows a ware washing installation with a ware cleaning appliance 2 and with a water treatment station 4 separated spatially from the latter. The water treatment station 4 is preferably arranged at least one storey lower than the ware cleaning appliance 2. As a result, water can flow out from the ware cleaning appliance 2 to the water treatment station 4 due to gravity, without a pump being required for this purpose. The storeys may be separated from one another by means of a building ceiling 6 or a false floor. The ware washing device 2 and the water treatment station 4 together form a conveyor-type ware washer in the form of a rack-conveyor ware washer or preferably, according to FIG. 1, in the form of a flight-type ware washer.

The ware cleaning appliance 2 contains at least one wash zone and, thereafter, at least one rinse zone. As an example, the ware cleaning appliance 2 shown in FIG. 1 has successively in the ware conveying direction 65 a first ware wash zone 8, a second ware wash zone 10, a third ware wash zone 12, a first rinse zone 14 and a second rinse zone 16. Ware is transported through the said zones 8 to 16 by an endless conveyor belt 18. Located in the zones 8 to 16 are nozzles for the spraying of water onto the ware, for example, above the conveyor belt 18, upper spray nozzles 20 in the wash zones 8, 10 and 12 and upper spray nozzles 21, 22, 23 in the rinse zones 14 and 16, and lower nozzles 28, arranged between the upper strand 24 and the lower strand 26 of the conveyor belt 18, in the wash zones 8, 10 and 12 and lower nozzles 29, 30, 31 in the rinse zones 14 and 16.

Located in each of the zones is a water-collecting floor 32, in each case with at least one water discharge orifice 34 in each of the wash zones 8, 10 and 12 and with a water discharge orifice 36 in the first rinse zone 14, the sprayed rinse water from both rinse zones 14 and 16 flowing out to the water discharge orifice 36 due to gravity by means of correspondingly obliquely configured zone floors.

All the abovementioned nozzles in the wash zones 8, 10 and 12 and in the rinse zones 14 and 16 direct the water sprayed by them towards the ware to be washed and the ware to be rinsed respectively.

A fresh-water supply line 40 for fresh water, preferably heated fresh water, can issue, according to FIG. 1, into one of the two rinse zones 14, 16, preferably into the first rinse zone 14, or into a rinse-water return line 42 connected to the water discharge orifice 36 of this first rinse zone 14, or into a first rinse-water storage tank 44. A valve arrangement 46 arranged in the fresh-water supply line 40 may be situated at the location of the ware cleaning appliance 2 or preferably at the location of the water treatment station 4.

A water feed line 48 for the supply of demineralized water (or, according to another embodiment, for the supply of fresh water), contains a valve arrangement 50 and is connected to a heat exchanger line 51 which extends over the upper spray nozzles 21, 22, 23 through both rinse zones 14 and 16, so that the demineralized water flowing through it is heated by the steam rising in the rinse zones 14 and 16. The demineralized water flows, downstream of the heat exchanger line 51, through a heating device 52 in the form of electrical heating or of a heat exchanger (also referred to as a booster) and is heated therein before it is sprayed onto the washed ware by the lower and upper spray nozzles 31 and 23 of the second (last) rinse zone 16.

The valve arrangement 50 of the water feed line 48 may be situated at the location of the ware cleaning appliance 2 or preferably at the location of the water treatment station 4.

A second rinse-water storage tank 56 receives rinse water from the first rinse-water storage tank 44 via a diaphragm filter 58 by means of gravity (or a pump). The second rinse-water storage tank 56 has a water overflow 60, from which overflowing water can flow back into the first rinse-water storage tank 44 through an overflow line 63.

A first rinse-water pump arrangement 62 is connected, in the water treatment station 4, with its suction side to a water outlet 64 of the first rinse-water storage tank 44 and is connected with its delivery side to the upstream start of a forward-flow line 66, the downstream end of which is connected, in the conveying direction 65 of the ware, to the first lower and upper spray nozzles 29 and 21 of the first rinse zone 14.

The first rinse-water pump arrangement 62 preferably consists of an operating pump 67, which has a conveying capacity sufficient for conveying the rinse water through the forward-flow line 66, and of a reserve pump 68 which is connected in parallel to the said operating pump and can be selectively switched on and which likewise has a conveying capacity sufficient for conveying the rinse water through the forward-flow line 66 and as a result, in the event of a failure of the operating pump 67, can fully assume the function of the latter.

A second forward-flow line 70 is connected at its upstream end to the delivery side of a second rinse-water pump arrangement 72, the suction side of which is connected to an outlet 74 of the second rinse-water storage tank 56. The second forward-flow line 70 is connected at its downstream end, via a heating device 76, to the lower 30 and the upper 22 spray nozzles which are arranged, in the ware conveying direction 65, between the first and last spray nozzles 21, 29, 23 and 31 of the two rinse zones 14 and 16. The heating device 76 may be a heat exchanger or an electrical heating body (booster).

The two heating devices 52 and 76 of the two rinse zones 14 and 16 are preferably arranged in the ware cleaning appliance 2 in order to avoid heat losses, but, according to another embodiment, may also be arranged in the water treatment station 4.

The second rinse-water pump arrangement 72 may consist of a single pump, but, according to the preferred embodiment, consists of an operating pump 77 and of a reserve pump 78 which is connected in parallel to the latter and which can be selectively switched on if the operating pump 77 fails because of a defect or on account of maintenance work. The operating pump 77 and the reserve pump 78 in each case have a capacity sufficient for conveying the rinse water.

The first rinse-water storage tank 44 preferably has a water overflow 80, from which water can flow through an overflow line 83 into a second wash-water storage tank 84.

Fresh water, preferably hot water, can be supplied to the second wash-water storage tank 84 via a valve arrangement 86 and a fresh-water feed line 88.

An outlet 90 of the second wash-water storage tank 84 is connected via a second wash-water pump arrangement 92 to the upstream end of a forward-flow line 94 which, downstream of a branch point 96, is flow-connected, via forward-flow line branches 98-1, 98-2, 98-3 and 98-4 parallel to one another, to the upper and lower spray nozzles 20 and 28 of the wash zones 10 and 12.

The branch point 96 of the forward-flow line 94 could be arranged, instead of in the ware cleaning appliance 2, in the water treatment station 4 directly on the delivery side of the second wash-water pump arrangement 92.

The second wash-water pump arrangement 92 preferably contains two operating pumps 102 and 104 which are connected in parallel to one another and each of which has sufficient capacity to supply one of the two wash zones 10 and 12 with wash water. Preferably, a reserve pump 106 is connected in parallel to the two operating pumps 102 and 104 and can be selectively switched on if one of the operating pumps 102 or 104 fails. The reserve pump 106 has the same pump capacity as one of the other two pumps.

A wash-water line 108, the purpose of which is described later, is connected to the forward-flow line 94 of the second wash-water storage tank 2 between the delivery side of the second wash-water pump arrangement 92 and the distributor point 96.

The second wash-water storage tank 84 has a water overflow device 120, from which water can flow out of the second wash-water storage tank 84 via an overflow line 122 into a first wash-water storage tank 124 which is provided with an overflow device 130, via which water can flow off through an overflow line 132. The first wash-water storage tank 124 is preferably provided with an emptying outflow 134.

If required, fresh water, preferably hot water, can be supplied to the first wash-water storage tank 124 via a valve arrangement 136 of a fresh-water feed line 138.

An outlet 140 of the first wash-water storage tank 124 is connected via a first wash-water pump arrangement 142 to the upstream end of a forward-flow line 146 which is divided, at a branch point 148, into two forward-flow line branches 146-1 and 146-2 which are parallel to one another and are connected respectively to the upper spray nozzles 20 and the lower spray nozzles 28 of the first wash zone 8. The branch point 148 may be arranged, according to FIG. 1, in the ware cleaning appliance 2 or, according to an embodiment not shown, in the water treatment station 4 on the delivery side of the first wash-water pump arrangement 142.

The first wash-water pump arrangement 142 preferably consists of an operating pump 152 and of a reserve pump 154 connected in parallel to the latter and capable of being selectively switched on. Both pumps 152 and 154 are designed for the conveying capacity required for conveying the wash water into the first wash zone 8, so that, in the event of a failure of the operating pump 152 in the case of a defect or during maintenance work, the reserve pump 154 can be switched on instead, so that, even in such a situation, the wash process in the wash zone 8 can be maintained unchanged.

The water discharge orifice 34 of the first wash zone 8 is flow-connected to a first screening device 170 via a return line 172. The wash water purified by the first screening device 170 flows into the first wash-water storage tank 124.

The water discharge orifices 34 of the second and third wash zones 10 and 12 are flow-connected to a second screening device 170 in each case via a return line 160 and 162 which can be connected to one another to form a common return line 164, soil being retained by the screen, and the wash water flowing downstream of the screening device into the second wash-water storage tank 84.

The screening devices 170 and 174 are preferably rotary screening devices which have a rotating screening cylinder 176 and 178 resp., into the interior of which the wash water of the return line 172 and 164, resp. is conducted. Wash water from the wash-water line 108 is conducted through the screening cylinders 176 and 178 from the outside inwards. In the screening cylinders 176 and 178 is located preferably a conveying element, preferably a worm 180 and 182, for the discontinuous or preferably continuous discharge of solids from the wash water which is located in the screening cylinder. The discharged solids are designated in FIG. 1 by 184 and 186 and are illustrated diagrammatically by an arrow.

A heating source 190, for example a heat exchanger or an electrical heating body, is preferably located in each case in the first rinse-water storage tank 44, the second wash-water storage tank 84 and/or the first wash-water storage tank 124.

The preferred embodiment of the invention, which is shown in FIG. 1, contains the following recirculation circuits: a first recirculation circuit, into which are integrated the forward-flow line 146 and the forward-flow line sections 146-1, 146-2, furthermore the return line 172, the first screening device 170, the first wash-water storage tank 124 and the first wash-water pump arrangement 142. Furthermore, a second recirculation circuit is provided, which contains the forward-flow lines or forward-flow line branches 94, 98-1, 98-2, 98-3, 98-4, the return lines 160, 162, 164, the second screening device 174, the second wash-water storage tank 84 and the second wash-water pump arrangement 92. A third recirculation circuit contains the forward-flow line 66, the return line 42, the first rinse-water storage tank 44 and the first rinse-water pump arrangement 62. The fourth recirculation circuit, the last in the conveying direction 65 of the ware, contains the forward-flow line 70, again the return line 42 and again the first rinse-water storage tank 44, the diaphragm filter 58, the second rinse-water storage tank 56 and the second rinse-water pump arrangement 72.

A particular advantage of the invention is that not only one ware cleaning appliance 2 can be connected to the water treatment station 4, but two or more ware cleaning appliances 2 can be connected to the single water treatment station 4. This may take place via additional forward-flow lines and return lines, which are flow-connected to the storage tanks 124, 84, 44 and 56 described and/or to the screening devices 170 and 174 described, or via parallel branches of the forward-flow lines described and of the return lines described, using the pump arrangements 72, 62, 92 and 142 already described. For this purpose, only valves or other shut-off elements 202, 204, 206, 208, 210, 212, 214, 216, 218 or 220 are required in each case in the forward-flow lines and in the parallel branches. Each of these ware cleaning appliances 2 forms, together with the common water treatment station 4, a specific conveyor-type ware washer.

According to an embodiment of the invention with a water treatment station 4 and with a plurality of ware cleaning appliances 2 connected to it, the water treatment station 4 has, for each ware cleaning appliance 2, a specific pump or pump group according to the pump arrangements 72, 62, 92 and 142 described. According to another preferred embodiment of the invention, the respective forward-flow lines of all the ware washing appliances 2 are connected to the pump arrangements 72, 62, 92 or 142 described with reference to FIG. 1, so that, in the way mentioned, each pump arrangement requires only a single reserve pump, irrespective of how many ware cleaning appliances 2 are connected to the common water treatment station 4. According to the preferred embodiment, each pump arrangement contains at least as many operating pumps 77, 67, 102 and 152 as there are ware cleaning appliances 2 provided, so that, in the event of a failure of such a pump, only one of these ware cleaning appliances 2 is affected, and this affected ware cleaning appliance can continue to be operated by means of the reserve pump 78, 68, 106, 154 of the respective pump arrangement. This means that, if only one ware cleaning appliance 2 is present, each pump arrangement contains at least one operating pump and a reserve pump; that, if two ware cleaning appliances 2 are present, each pump arrangement contains at least two operating pumps and a reserve pump; that, if three ware cleaning appliances 2 are used, each pump arrangement contains three operating pumps and a reserve pump; and so on and so forth. As a result, the pump capacity necessary for the reserve situation is reduced to a single reserve pump in each pump arrangement. Two or more reserve pumps may also be connected in parallel to an operating pump or a group of operating pumps and be capable of being selectively cut in.

The invention relates particularly to commercial ware washing installations.

The patent claims relate to examples of preferred embodiments of the invention. However, the invention also relates to the use of each individual feature and of subcombinations of features which are disclosed in the patent claims, the description and/or the drawings.

1. Ware washing installation, containing at least one conveyor-type ware washer, characterized in that the at least one conveyor-type ware washer is divided into a ware cleaning appliance and a water treatment station arranged spatially separately from each other, and in that at least one recirculation circuit is formed, in which water is recirculated from the water treatment station to the ware cleaning appliance and back again, the recirculation circuit having, in the ware cleaning appliance spray nozzles for the spraying of water onto the ware and at least one water discharge orifice for the recirculation of sprayed water back to the water treatment station.

2. Ware washing installation according to claim 1, characterized in that the water treatment station is arranged at least one storey lower than the ware cleaning appliance.

3. Ware washing installation according to claim 1, characterized in that the water treatment station is arranged on the same storey as the ware cleaning appliance.

4. Ware washing installation according to claim 1, characterized in that the water treatment station has at least one water purification device which is integrated in each case into at least one of the recirculation circuits.

5. Ware washing installation according to claim 4, characterized in that the water purification device has at least one screening device and/or at least one filter device for purifying the water.

6. Ware washing installation according to claim 5, characterized in that the screening device has a rotating screening cylinder through which the water is conducted, and a solids discharge device for the discharge of solids from the water in the interior of the screening cylinder.

7. Ware washing installation according to claim 1, characterized in that the water treatment station has at least one water storage tank which is integrated in each case into one of the recirculation circuits and which has a recirculation-water inlet and a recirculation-water outlet.

8. Ware washing installation according to claim 7, characterized in that the water storage tank has a heating device for heating the water.

9. Ware washing installation according to claim 1, characterized in that, in the water treatment station at least one operating pump or operating-pump group is integrated into the recirculation circuit, for the conveyance of water from the water treatment station (4) to the ware cleaning appliance.

10. Ware washing installation according to claim 1, characterized in that the ware cleaning appliance has a plurality of zones which are in each case assigned to another of the recirculation circuits.

11. Ware washing installation according to claim 1, characterized in that the ware cleaning appliance has at least two zones, and in that at least one of the recirculation circuits has parallel branches, of which one parallel branch is assigned to one of the zones and another parallel branch is assigned to another one of the zones of the ware cleaning appliance.

12. Ware washing installation according to claim 1, characterized in that the water treatment station has connected to it a plurality of ware cleaning appliances which are arranged in each case spatially separately from the water treatment station and, together with this same water treatment station, form a number of conveyor-type ware washers which is equal to the number of ware cleaning appliances, there being formed between each ware cleaning appliance and the water treatment station at least one of the recirculation circuits, or a parallel recirculation circuit, in which water is recirculated from the water treatment station to the respective ware cleaning appliance and back again, and each recirculation circuit or parallel recirculation circuit having, in the respective ware cleaning appliance, spray nozzles for the spraying of water onto the ware and at least one water discharge orifice for the recirculation of sprayed water back to the water treatment station.
